(19) United States
(12) Patent Application Publication
(10) Pub. No.: US 2005/0133105 A1
(43) Pub. Date: Jun. 23, 2005

(54) Device and a process for non-destructive repair of a side inlet pipe of a main sewer of a draining pipe

(75) Inventor: Francesco Paolo Criffo', Segrate (Milano) (IT)

Correspondence Address: THE FIRM OF KARL F ROSS, 5676 RIVERDALE AVENUE, PO BOX 900, RIVERDALE (BRONX), NY, 10471-0900, US

(73) Assignee: IN.TEC S.r.l.

(21) Appl. No.: 10/987,576

(22) Filed: Nov. 12, 2004

(30) Foreign Application Priority Data
Nov. 12, 2003 (IT) MI2003A002182

(51) Int. Cl. F16L 55/16

(52) U.S. Cl. 138/98; 138/97; 156/287; 264/269; 405/150.1

(57) ABSTRACT

The device for non-destructive repair of a side inlet pipe of a main sewer of a sewer system or of a draining pipe in general comprises a repair coating element impregnated with thermosetting resin and slotted onto an inflatable positioning balloon connected to a longitudinal moving element that can be actuated manually along the side pipe, the coating element having a first tubular portion that can be shaped to the inner wall of the side pipe for its repair and a second portion that can be shaped to the inner wall of said main sewer about the outlet hole of the side pipe to ensure the correct positioning of the first tubular portion and to avoid it slipping off after positioning.

### DESCRIPTION

The present invention refers to a device and a process for non-destructive repair of a side inlet pipe of a main sewer of a sewer system or of a draining pipe in general.

For some time systems for non-destructive repair of a side inlet pipe of a main sewer of a sewer system or of a draining pipe have been present on the market, in which the coating element for repairing the side pipe, housed bent back upon itself in a suitable container and suitably impregnated with a thermosetting resin, is transported onto the location to be repaired by a robitized machine, once the location has been reached it is subjected to a pressurised air jet that everts it so as to fit onto the side pipe, and finally it is rigidified by triggering the polymerisation of the resin.

It is known that such systems for non-destructive repair of a side inlet pipe of a main sewer of a sewer system or of a draining pipe in general are extremely complex and expensive since they cannot do without the use of a robotized machine for positioning the coating element, whereas the everting device does not always ensure the desired performance and end result.

The technical task proposed of the present invention is, therefore, that of making a device and a process for non-destructive repair of a side inlet pipe of a main sewer of a sewer system or of a draining pipe in general that allow the aforementioned technical drawbacks of the prior art to be eliminated.

In this technical task a purpose of the invention is that of making a device and a process for non-destructive repair of a side inlet pipe of a main sewer of a sewer system or of a draining pipe in general that capable of always ensuring the desired performance and end result in a cost-effective, simple and quick manner, without the help of robotized machines.

The technical task, as well as these and other purposes, according to the present invention, are accomplished by making a device for non-destructive repair of a side inlet pipe of a main sewer of a sewer system or of a draining pipe in general, characterised in that it comprises a coating element for repairing said side pipe, impregnated with thermosetting resin and slotted onto an inflatable positioning balloon rigidly connected to a longitudinal moving element that can be actuated manually along said side pipe, said coating element having a first tubular portion that can be shaped to the inner wall of said side pipe for its repair and a second portion that can be shaped to the inner wall of said main sewer about the outlet hole of said side pipe to ensure the correct positioning of said first tubular portion and to avoid it slipping off after positioning.

The present invention also refers to a process for non-destructive repair of a side inlet pipe of a main sewer of a sewer system or of a draining pipe in general, characterised in that it foresees an inflatable positioning balloon connected to a moving element, slotting a coating element for repairing said side pipe impregnated with thermosetting resin onto said balloon, making said moving element rise from said main sewer to said side pipe, pulling it manually until a first tubular portion of said balloon is positioned in said side pipe and a second tubular portion of said balloon is positioned in said main sewer, inflating said balloon so as to shape said first tubular portion to the inner wall of said side pipe for its repair and said second tubular portion to the inner wall of said main sewer about the outlet hole of said side pipe to ensure the correct positioning of said first tubular portion and to avoid it slipping off after positioning, polymerising said resin with which said coating element is impregnated and deflating and removing said balloon from said coating element.

The present invention also discloses a process for non-destructive repair of a side inlet pipe of a main sewer of a sewer system or of a draining pipe in general, characterised in that it foresees an inflatable positioning balloon connected to a longitudinal moving element, slotting a coating element for repairing said side pipe impregnated with thermosetting resin onto said balloon, making said moving element descend from said side tube to said main sewer, pushing it manually until a first tubular portion of said coating element is positioned in said side pipe and a second portion of said coating element is positioned in said main sewer, inflating said balloon so as to shape said first tubular portion to the inner wall of said side pipe for its repair and said second portion to the inner wall of said main sewer about the outlet hole of said side pipe to ensure the correct positioning of said first tubular portion and to avoid it slipping off after positioning, polymerising said resin with which said coating element is impregnated and deflating and removing said balloon from said coating element.

Other characteristics of the present invention are, moreover, defined in the subsequent claims.

Further characteristics and advantages of the invention shall become clearer from the description of a preferred but not exclusive embodiment of the device and a process for non-destructive repair of a side inlet pipe of a main sewer of a sewer system or of a draining pipe in general according to the finding, illustrated for indicating and not limiting purposes in the attached drawings, in which:

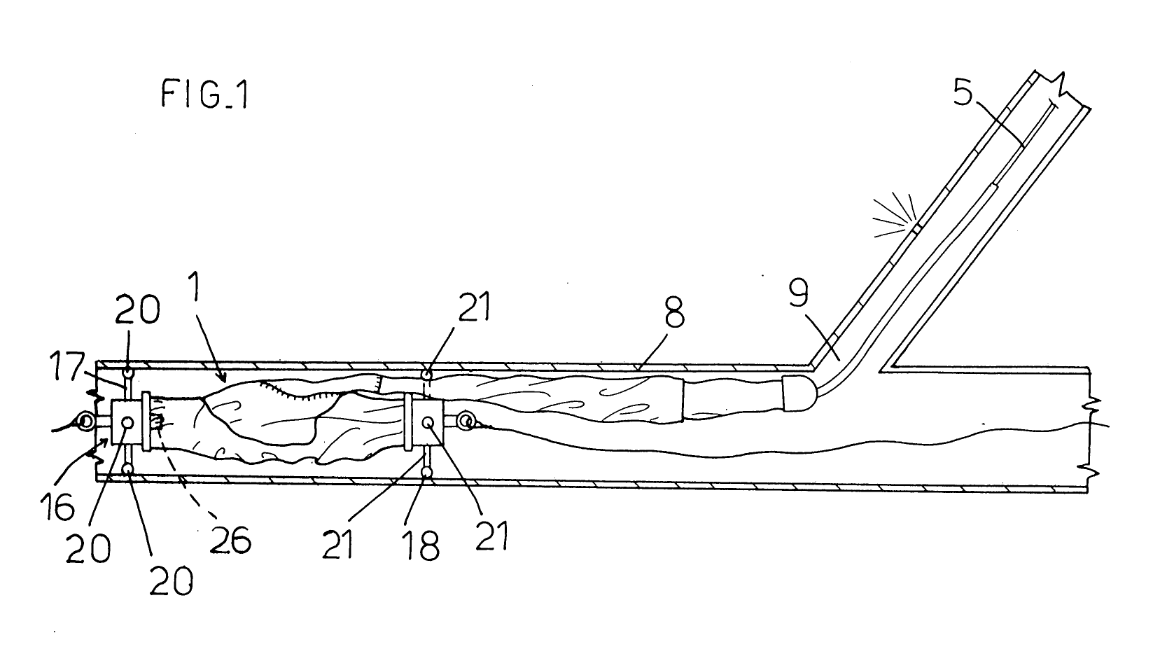

FIG. 1 shows a view of a first embodiment of the device for non-destructive repair of a side inlet pipe of a main sewer of a sewer system or of a draining pipe in general, before positioning and inflation of the balloon, in which the system for positioning the balloon is by traction and the repair intervention requires the flow of refluent through the main pipe to be momentarily shut off;

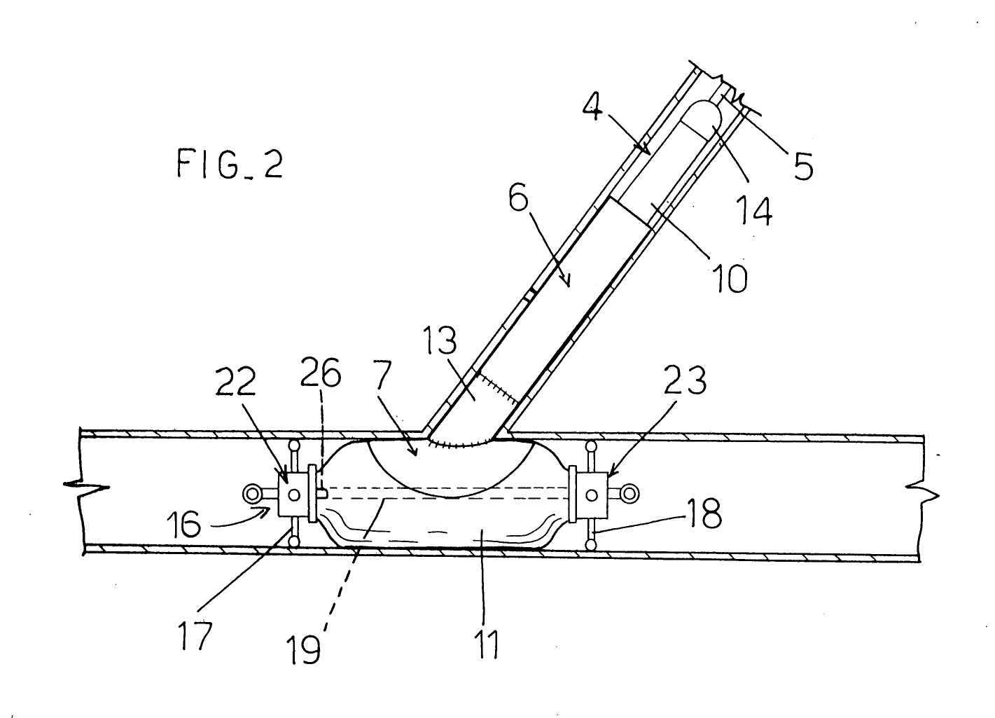

FIG. 2 shows the device of FIG. 1 after the positioning and inflation of the balloon;

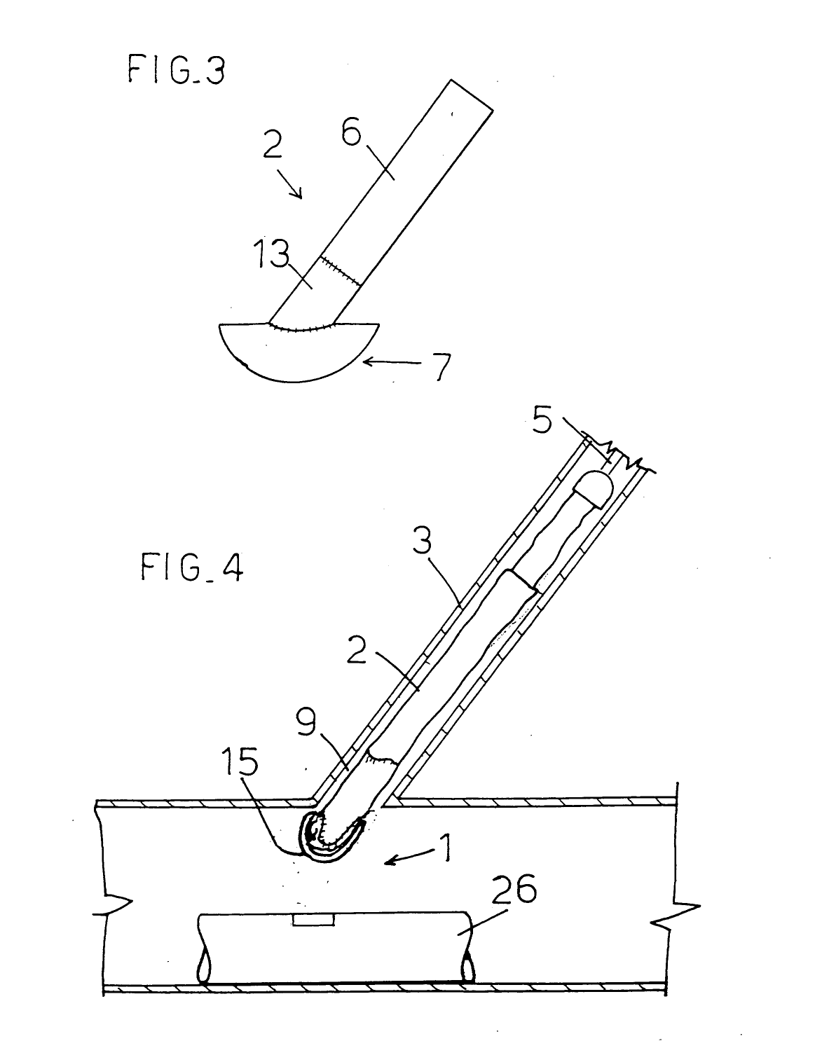

FIG. 3 shows a side elevated view of the coating element for repairing the side pipe;

FIG. 4 shows a view of a second embodiment of the device for non-destructive repair of a side inlet pipe of a main sewer of a sewer system or of a draining pipe in general, before inflation of the balloon, in which the system for positioning the balloon is by thrust and the repair intervention does not require the flow of refluent through the main pipe to be shut off;

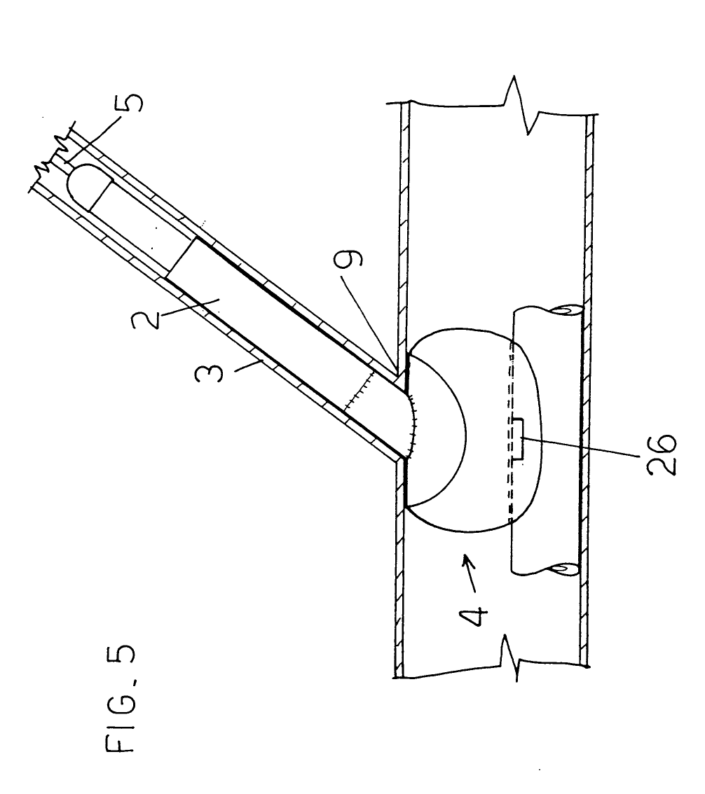

FIG. 5 shows the device of FIG. 4 after inflation of the balloon;

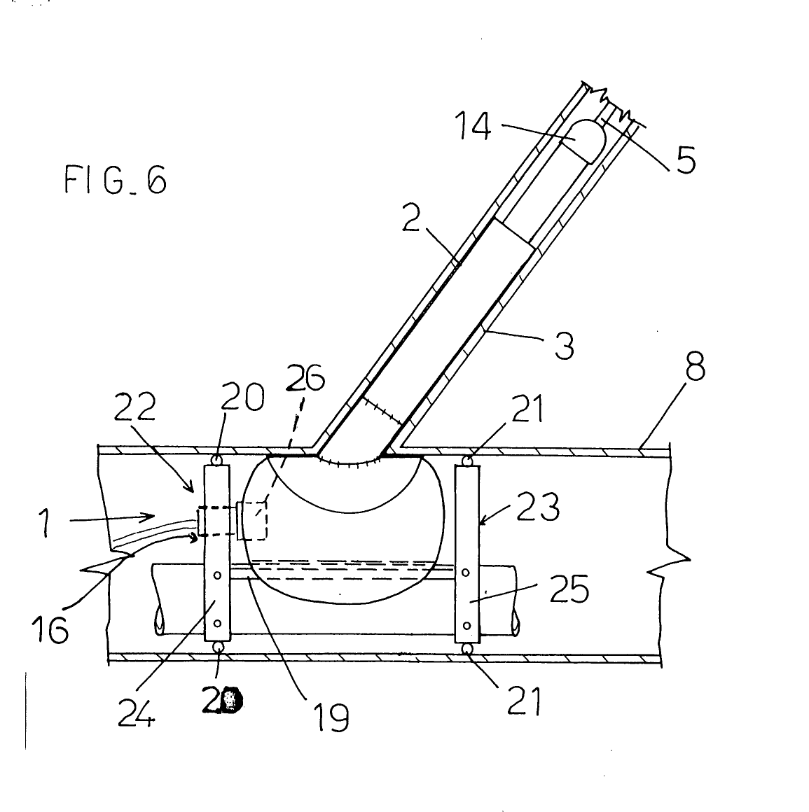

FIG. 6 shows a view of a third embodiment of the device for non-destructive repair of a side inlet pipe of a main sewer of a sewer system or of a draining pipe in general, in which the system for positioning the balloon is by traction and the repair intervention does not require the flow of refluent through the main pipe to be shut off.

In the description elements that are equivalent in the different embodiments shall be indicated with the same reference numeral.

With reference to the quoted figures, a device for non-destructive repair of a side inlet pipe of a main sewer of a sewer system or of a draining pipe in general is shown, wholly indicated with reference numeral 1.

The device 1 comprises a coating element 2 for repairing the side pipe 3, impregnated with a thermosetting resin and slotted onto an inflatable positioning balloon 4 connected to a longitudinal moving element 5 that can be actuated manually along the side pipe 3.

The repair element 2 has a first tubular portion 6 that can be shaped to the inner wall of the side pipe 3 and a second portion 7 that can be shaped to the inner wall of the main sewer 8 about the outlet hole 9 of the side pipe 3 both to ensure the correct positioning of the first tubular portion 6 and to avoid it slipping off after positioning.

The repair element 2 can consist of non-woven fabric, felt or another material and advantageously it has a layer of anti-friction, anti-wear and impermeable material, e.g. nylon, on the outside, in other words on the opposite side to the one facing towards the balloon 4.

The second portion 7 of the repair element 2 preferably consists of a substantially annular skirt from the inner edge of which extends a tubular fitting 13 with the first tubular portion 6 of the repair element 2.

In particular, the fitting 13 is joined on one side to the first portion 6 and on the other side to the second portion 7 of the repair element 2.

The first portion 6 of the repair element 2 is made from flexible material, whereas the second portion 7 and the fitting 13 are made from rigid or semi-rigid material.

The balloon 4 has a first tubular chamber 10 that can be shaped to the first tubular portion 6 of the repair element 2 and to the fitting 13 and a second tubular chamber 11 that can be shaped to the second portion 7.

The outer layer of the repair element 2, as well as easing the sliding of the repair element 2 along the inner walls of the pipe 3 and/or 8, thus avoids the resin being able to disperse by contact along the inner walls of the pipe 3 and/or 8.

The longitudinal moving element 5 extends at least along the entire longitudinal extension of the first chamber 10 of the balloon 4, and has an axial recess for the circulation of a hot fluid, for example air or water, suitable for promoting the polymerisation of the resin after the inflation of the balloon 4.

Structurally, the longitudinal moving element 5 has longitudinal flexibility, resistance to compression and to traction, and resistance to torsion given by suitable torsional rigidifying means.

Indeed, in a preferred embodiment the moving element 5 is a pipe made from thermoplastic material, strengthened by a metal torsional rigidifying mesh (not shown).

The moving element 5 is rigidly fixed to the balloon 4 so as to avoid the latter being able to undergo a torsional displacement that could hinder the functionality of the device 1 and in particular the correct expansion of the balloon 4.

In the traction positioning system of the balloon 4 illustrated in FIGS. 1, 2 and 6, the end of the first chamber 10 opposite the second chamber 11 of the balloon 4 carries a rounded cap 14, suitable for easing the introduction of the first chamber 10 of the balloon 4 into the side pipe 3, through the wall thickness of which the moving element 5 is advantageously rigidly fixed.

In the thrust positioning system of the balloon 4 illustrated in FIGS. 4 and 5, on the other hand, the end of the first chamber 10 adjacent to the second chamber 11 has an openable capsule 15 in which, before the balloon 4 is inflated, the second chamber 11 of the balloon 4 and the second portion 7 of the repair element 2 are collected.

The capsule 15 is suitable for containing the second chamber 11 of the balloon 4 and the second portion 7 of the repair element 2 substantially inside the generatrices of the first chamber 10 of the balloon 4 so as to allow the sliding of the balloon 4 inside the side pipe 3.

With reference to FIGS. 1, 2 and 6, the device 1 has a support trolley 16 for the balloon 4, able to slide in the main sewer 8. The trolley 16 has a first and a second guide 22 and 23 arranged at the axial ends of the second chamber 11 of the balloon 4 and rigidly connected through at least one rod 19 that extends parallel to the axis of the second chamber 11 of the balloon 4.

Respective balls 20 and 21, which allow the self-positioning of the trolley 16 in the main sewer 8, are rotatably associated with each guide 22 and 23 respectively.

In FIGS. 1 and 2 the guide 22 and 23, respectively, comprises a set of three feet 17 and 18, respectively, which carry the respective balls 20 and 21 at their free ends.

In FIG. 6, on the other hand, the guide 22 and 23, respectively, comprises a circumferential band 24 and 25, respectively, which carries the respective balls 20 and 21.

Between the first and second guide 22 and 23 a space is defined adjacent to the second chamber 11 along which the first chamber 10 is arranged before the balloon 4 is inflated.

Now with reference to FIGS. 4-6, the device 1 foresees a spacer arranged between the second chamber 11 of the balloon 4 and the inner wall of the main sewer 8, suitable for creating a continuous fluid passage along the main sewer 8 even when the balloon 4 is inflated.

Advantageously, the spacer consists of a pipe 26 that, being positioned longitudinally between the second chamber 11 of the balloon 4 and the inner wall of the main sewer 8 when the balloon 4 is inflated, allows a fluid passage through its section to be maintained.

The spacer can be mounted on the trolley 16, as shown in FIG. 6, or else it can constitute an independent element, as shown in FIGS. 4 and 5.

Finally, the device 1 has a television camera 26, carried by the spacer, as shown in FIGS. 4 and 5, or by the trolley 16 inside the balloon, as shown in FIGS. 1 and 2.

The process for non-destructive repair of the side pipe 3 is briefly the following.

The preliminary operations of course consist of inspecting the side pipe 3, washing and/or cleaning and detecting the point to be repaired.

In the system of FIGS. 1, 2 and 6, the operator, from a manhole for accessing the side pipe 3, pulls the moving element 5 that drags the device along the main sewer 8 until the junction with the side pipe 3.

The sliding of the device 1 terminates at the position where the second portion 7 of the repair element 2 and the inner wall of the main sewer 8 meet around the hole 9.

In such apposition the balloon 4 is inflated, so that the first tubular portion 6 of the repair element 2 and the tubular fitting 13 shape to the inner wall of the side pipe 3, whereas the second portion 7 shapes to the inner wall of the main sewer 8 around the outlet hole 9 of the side pipe 3.

After the balloon 4 has been inflated the configuration of the repair element 2 is consolidated by circulating a hot fluid inside the moving element 5 that activates the polymerisation of the resin with which the repair element 2 itself is impregnated.

At the end of polymerisation of the resin the balloon 4 is deflated and removed from the repair element 2.

The television camera 26 monitors that the procedure has been carried out correctly from inside the balloon, verifying the complete inflation of the balloon 4.

In FIGS. 1 and 2 the inflated balloon 4 completely blocks the section of the main sewer 8 and momentarily interrupts the drainage of refluent, whereas in FIG. 6 the spacer against which the inflated balloon 4 adapts itself allows continuous disposal of refluent through the main sewer 8.

In the system of FIGS. 4 and 5, the preliminary operation consists of detecting the position of the junction between the main sewer 8 and the side pipe through the insertion of the spacer incorporating the television camera 26.

The spacer is reinserted into the position previously detected by the television camera 26, and the operator pushes the moving element 5, from a manhole for accessing the side pipe 3, which in turn pushes the device 1 along the side pipe up the junction with the main sewer 8 previously detected by the television camera 26.

In such a position the opening of the capsule 15 is commanded to carry out the release of the second chamber 11 of the balloon 4 and of the second portion 7 of the repair element 2 inside the main sewer 8.

At this point the balloon 4 is inflated, so that the first tubular portion 6 and the tubular fitting 13 of the repair element 2 are shaped to the inner wall of the side pipe 3, whereas the second portion 7 shapes to the inner wall of the main sewer 8 around the outlet hole 9 of the side pipe 3.

After the balloon 4 has been inflated the configuration of the repair element 2 is consolidated by circulating a hot fluid inside the moving element 5 that activates the polymerisation of the resin with which the repair element 2 itself is impregnated. At the end of the polymerisation of the resin the balloon 4 is deflated and removed from the repair element 2 itself.

In this case the balloon 4 inflates adapting itself to the spacer that allows the continuous drainage of refluent through the main sewer 8.

The device and a process for non-destructive repair of a side inlet pipe of a main sewer of a sewer system or of a draining pipe in general thus conceived can undergo numerous modifications and variants, all of which are covered by the inventive concept; moreover, all of the details can be replaced with technically equivalent elements.

In practice, the materials used, as well as the sizes, can be whatever according to the requirements and the state of the art.

1. A device for non-destructive repair of a side inlet pipe of a main sewer of a sewer system or of a draining pipe comprising a coating element for repairing said side pipe, impregnated with thermosetting resin and slotted onto an inflatable positioning balloon connected to a longitudinal moving element that can be actuated manually along said side pipe, said coating element having a first tubular portion that can be shaped to the inner wall of said side pipe for its repair and a second portion that can be shaped to the inner wall of said main sewer about an outlet hole of said side pipe to ensure a correct positioning of said first tubular portion and to avoid it slipping off after positioning.

2. A device according to claim 1, wherein said second portion consists of a skirt connected through a tubular fitting to said first tubular portion.

3. The device defined in claim 1 wherein said thermosetting resin is suitable for consolidating the configuration taken up by said coating element when said balloon is inflated.

4. The device defined in claim 1 wherein said coating element has an outer layer made from a material that is anti-friction, anti-wear and impermeable to said resin.

5. The device defined in claim 2 wherein said first portion of said coating element is made from flexible material, whereas said second portion and said fitting of said coating element are made from rigid or semi-rigid material.

6. The device defined in claim 1 wherein said balloon has a first tubular chamber that can be shaped to said first portion and to said fitting of said coating element and a second tubular chamber that can be shaped to said second portion of said coating element.

7. The device defined in claim 1 wherein said longitudinal moving element has an axial recess for the circulation of a hot fluid suitable for promoting the polymerization of said resin after said balloon has been inflated.

8. The device defined in claim 1 wherein said longitudinal moving element is flexible and resistant to compression and has torsion rigidifying means.

9. The device defined in claim 8 wherein said torsion rigidifying means comprise a metal mesh shell.

10. The device defined in claim 6 wherein moving element extends at least along the entire longitudinal extension of said first chamber of said balloon.

11. The device defined in claim 10 wherein an end of said first chamber opposite said second chamber carries a rounded cap suitable for easing the introduction of said first chamber into said side pipe.

12. The device defined in claim 11 wherein said longitudinal moving element is rigidly fixed through the wall thickness of said cap.

13. The device defined in claim 11 wherein the end of said first chamber adjacent to said second chamber has an openable capsule in which, before said balloon is inflated, said second chamber of said balloon and said second portion of said repair element are collected.

14. The device defined in claim 1 which has a support trolley for said balloon, able to slide in said main sewer.

15. The device defined in claim 14 wherein said trolley has a first and second guide having self-positioning balls of said trolley in said main sewer.

16. The device defined in claim 15 wherein said first and second guide are rigidly connected through at least one rod that extends longitudinally parallel to the axis of said second chamber of said balloon.

17. The device defined in claim 16 wherein said first and second guide, respectively, comprise a respective first and second set of three angularly spaced support feet with the free ends of which said balls are rotatably associated.

18. The device defined in claim 17 wherein said first and second guide, respectively, comprise a respective first and second circumferential band with which said balls are rotatably associated.

19. The device defined in claim 16 which has a spacer of said second chamber of said balloon from said main sewer, suitable for creating a continuous fluid passage along said main sewer even when said balloon is inflated.

20. The device defined in claim 19 wherein said spacer is a pipe.

21. The device defined in claim 19 wherein said spacer is carried by said trolley.

22. The device defined in claim 19 wherein said spacer is detached from said trolley.

23. The device defined in claim 19 which it has a television camera.

24. The device defined in claim 23 wherein said television camera is carried by said spacer.

25. The device defined in claim 23 wherein said television camera is carried by said trolley inside said balloon.

26. The process for non-destructive repair of a side inlet pipe of a main sewer of a sewer system or of a draining pipe in general, which comprises providing an inflatable positioning balloon connected to a longitudinal moving element, slotting a coating element for repairing said side pipe impregnated with thermosetting resin onto said balloon, making said moving element rise from said main sewer to said side pipe, pulling said moving element manually until a first flexible tubular portion of said balloon is positioned in said side pipe and a second rigid or semi-rigid tubular portion of said coating element is positioned in said main sewer, inflating said balloon so as to shape said first tubular portion to the inner wall of said side pipe for its repair and said second portion to the inner wall of said main sewer about the outlet hole of said side pipe to ensure the correct positioning of said first tubular portion and to avoid it slipping off after positioning, polymerising said resin to consolidate the configuration taken up by said coating element and deflating and removing said balloon from said coating element.

27. A process for repairing a side outlet pipe of a main sewer of a sewer system or of a draining pipe in general, which comprises an inflatable positioning balloon connected to a longitudinal moving element, slotting a coating element for repairing said side pipe impregnated with thermosetting resin onto said balloon, making said moving element descend from said side tube to said main sewer, pushing said moving element manually until a first flexible tubular portion of said coating element is positioned in said side pipe and a second rigid or semi-rigid portion of said coating element is positioned in said main sewer, inflating said balloon so as to shape said first tubular portion to the inner wall of said side pipe for its repair and said second portion to the inner wall of said main sewer about the outlet hole of said side pipe to ensure the correct positioning of said first tubular portion and to avoid it slipping off after positioning, polymerising said resin to consolidate the configuration taken up by said coating element and deflating and removing said balloon from said coating element.

28. The process according to either of claim 26 wherein said first tubular portion is associated with a first tubular chamber of said balloon, and said second portion is associated with a second tubular chamber of said balloon.

29. The process according to claim 26 wherein a spacer of said balloon from said main sewer is inserted in said main sewer before said balloon is inflated to create a continuous fluid passage along said main sewer even when said balloon is inflated.

30. The process according to claim 27 first tubular portion is associated to a first tubular portion of the balloon and the balloon has a second tubular portion , said method comprising, before said balloon is inflated, the steps of encapsulating said second tubular chamber and said second portion of said coating element so as to contain them substantially inside the generatrices of said first chamber of said balloon and to allow it to slide in said side pipe, detecting the position of said hole, positioning a spacer of said balloon from said main sewer in said main sewer in said position thus detected to create a continuous fluid passage along said main sewer, and removing the encapsulation of said second tubular chamber and said second portion of said coating element when they are positioned in said main sewer and said first portion of said coating element is positioned in said side pipe.

31. Process according to claim 30 wherein a hot fluid is circulated inside said longitudinal moving element to activate the polymerisation of a thermosetting resin associated with said coating element after said balloon has been positioned and inflated.

32. (canceled)
